(19) United States
(12) Patent Application Publication
(10) Pub. No.: US 2024/0134517 A1
(43) Pub. Date: Apr. 25, 2024

(54) TOUCHPAD WITH MULTIPLE ZONES FOR DIFFERENT USER INTERFACE FUNCTIONALITY

(71) Applicant: Dell Products L.P., Round Rock, TX (US)

(72) Inventors: Jiahui DING, Shanghai (CN); Kai WANG, Shanghai (CN)

(73) Assignee: Dell Products L.P., Round Rock, TX (US)

(21) Appl. No.: 17/978,310

(22) Filed: Oct. 31, 2022

(30) Foreign Application Priority Data
Oct. 19, 2022 (CN) 202211290659.6

(51) Int. Cl. G06F 3/04886; G06F 3/0354; G06F 3/038; G06F 3/14

(52) U.S. Cl. CPC G06F 3/04886; G06F 3/03547; G06F 3/038; G06F 3/1423

(57) ABSTRACT

An information handling system may include a processor, a touchpad communicatively coupled to the processor, and non-transitory computer-readable media communicatively coupled to the processor and having stored thereon a program of instructions configured to, when read and executed by the processor in response to a trigger for enabling logical segmentation of the touchpad, logically segment the touchpad into a plurality of zones and map each zone to a respective corresponding feature displayed on one or more displays communicatively coupled to the processor such that user interaction with each of the plurality of zones manipulates the respective corresponding feature of such zones on the one or more displays.

### TECHNICAL FIELD

The present disclosure relates in general to information handling systems, and more particularly to a touchpad for use in an information handling system, wherein the touchpad is capable of being divided into multiple zones, each zone having a different user interface functionality.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems utilize a touchpad. A touchpad may comprise a pointing device that includes a tactile sensor that may translate motion and position of a user's fingers (or other pointing device, such as a stylus) to a relative position on a display device of an information handling system.

Increasingly, users of information handling systems prefer to use external displays, in addition to the integrated display of a notepad/laptop, for multiple tasks. However, when using a touchpad, moving a cursor between the two displays may be inefficient, especially for larger displays.

### SUMMARY

In accordance with the teachings of the present disclosure, the disadvantages and problems associated with movement of a cursor between display devices may be reduced or eliminated.

In accordance with embodiments of the present disclosure, an information handling system may include a processor, a touchpad communicatively coupled to the processor, and non-transitory computer-readable media communicatively coupled to the processor and having stored thereon a program of instructions configured to, when read and executed by the processor in response to a trigger for enabling logical segmentation of the touchpad, logically segment the touchpad into a plurality of zones and map each zone to a respective corresponding feature displayed on one or more displays communicatively coupled to the processor such that user interaction with each of the plurality of zones manipulates the respective corresponding feature of such zones on the one or more displays.

In accordance with these and other embodiments of the present disclosure, a method may include logically segmenting a touchpad of an information handling system into a plurality of zones and mapping each zone to a respective corresponding feature displayed on one or more displays communicatively coupled to a processor of the information handling system such that user interaction with each of the plurality of zones manipulates the respective corresponding feature of such zones on the one or more displays.

In accordance with these and other embodiments of the present disclosure, an article of manufacture may include a non-transitory computer readable medium and computer-executable instructions carried on the computer readable medium, the instructions readable by a processing device, the instructions, when read and executed, for causing the processing device to logically segment a touchpad of an information handling system into a plurality of zones and map each zone to a respective corresponding feature displayed on one or more displays communicatively coupled to a processor of the information handling system such that user interaction with each of the plurality of zones manipulates the respective corresponding feature of such zones on the one or more displays.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a perspective view of an example information handling system, in accordance with embodiments of the present disclosure;

FIG. 2 illustrates an external display communicatively coupled to an information handling system, in accordance with embodiments of the present disclosure;

FIG. 3 illustrates the logical segmentation of a touchpad into a first zone for manipulating a first display and a second zone for manipulating a second display, in accordance with embodiments of the present disclosure;

FIG. 4 illustrates the logical segmentation of a touchpad into a first zone for manipulating a first segment of a display, a second zone for manipulating a second segment of the same display, and a third zone for manipulating a third segment of the same display, in accordance with embodiments of the present disclosure;

FIG. 5 illustrates a functional block diagram of an example information handling system, in accordance with embodiments of the present disclosure; and

FIG. 6 illustrates a flow chart of an example method for enabling a touchpad with multiple zones for different user interface functionality, in accordance with embodiments of the present disclosure.

### DETAILED DESCRIPTION

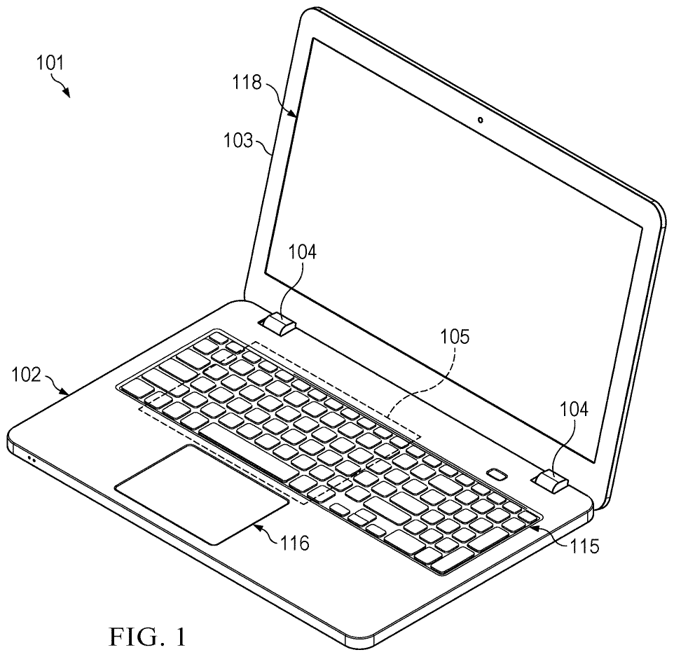

Preferred embodiments and their advantages are best understood by reference to FIGS. 1 through 6, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a perspective view of an example information handling system 101, in accordance with embodiments of the present disclosure. As depicted in FIG. 1, information handling system 101 may comprise a notebook or “laptop” computer. In other embodiments, information handling system 101 may comprise a mobile device sized and shaped to be readily transported and carried on a person of a user of information handling system 101 (e.g., a smartphone, a tablet computing device, a handheld computing device, a personal digital assistant, etc.). As illustrated in FIG. 1, information handling system 101 may comprise a first housing 102, a second housing 103 and one or more hinges 104. First housing 102 may comprise, for example, a main body housing. Accordingly, in some embodiments, a circuit board 105 and other information handling resources may be housed within first housing 102. Circuit board 105 may include one or more information handling resources, including without limitation, one or more processors, one or more memories, and/or one or more peripheral devices.

As also shown in FIG. 1, first housing 102 may include keyboard 115 and a touchpad 116. Keyboard 115 and touchpad 116 may each comprise input devices for receiving input from a user to allow the user to control operation of information handling system 101. In some embodiments, information handling system 101 may comprise other input devices in addition to or instead of keyboard 115 and/or touchpad 116.

As illustrated in FIG. 1, second housing 103 may include a display housing and may comprise a display 118 (e.g., a display device or a display module) communicatively coupled to circuit board 105.

Hinge(s) 104 may rotatably couple first housing 102 to second housing 103. Thus, information handling system 101 may be openable and closable (i.e., foldable). In other words, information handling system 101 may be transformable between a first state in which first housing 102 and second housing 103 overlap each other, and a second state in which first housing 102 and second housing 103 are opened and keyboard 115, touchpad 116, and display 118 are exposed to the outside.

Touchpad 116 may comprise an input device having the function of a pointing device and a push button. That is, touchpad 116 may associate a movement of a finger, stylus, or other pointing device tracing the surface of touchpad 116 with the movement of a mouse pointer on a screen of display 118.

The information handling system to which a touchpad 116 as described herein can be applied is not limited to the above example of a notebook information handling system having two hinged housings, and may be broadly applied to various types of electronic apparatuses such as a tablet terminal, a television, a cellular phone (including a smartphone), a game console, and/or other information handling systems that include a single housing. In one or more of such devices, a touchscreen may effectively include the functionality of a touchpad and a display.

Although not explicitly shown in FIG. 1, information handling system 101 may include a clicking device (e.g., button or mechanism integrated within touchpad 116) to perform the same function as clicking on a button of a mouse or other device.

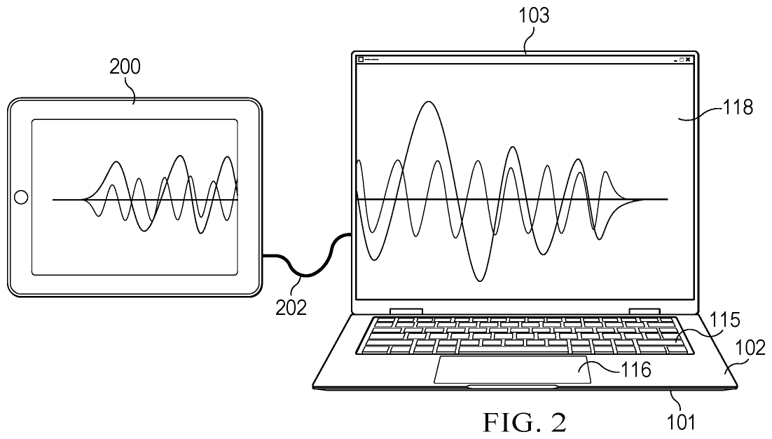

FIG. 2 illustrates an external display 200 communicatively coupled to information handling system 101 via a cable 202, in accordance with embodiments of the present disclosure. Accordingly, a user interfacing with information handling system 101 via input devices (e.g., keyboard 115, touchpad 116) may manipulate text, images, and/or other objects on external display 200.

Although external display 200 is depicted as being coupled via a wired connection using cable 202, in some embodiments, both information handling system 101 and external display 200 may be enabled to communicatively coupled via wireless transmission (e.g., Bluetooth).

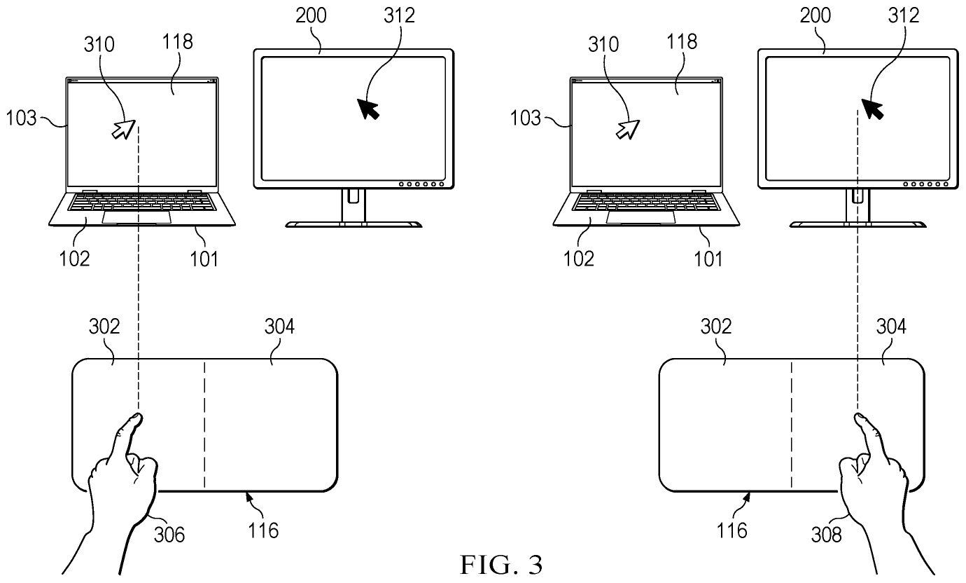

FIG. 3 illustrates the logical segmentation of touchpad 116 into a first zone 302 for manipulating a first display (e.g., display 118) and a second zone 304 for manipulating a second display (e.g., external display 200), in accordance with embodiments of the present disclosure. As shown, and as described in greater detail below, an operating system and touchpad drivers executing on information handling system 101 may be configured to selectively enable and disable the segmentation of touchpad 116 and further configured to, when segmentation is enabled, process user interaction 306 with first zone 302 to manipulate the first display (e.g., to manipulate a cursor 310 and/or other feature displayed on the first display) and process user interaction 308 with second zone 304 to manipulate the second display (e.g., to manipulate a cursor 312 and/or other feature displayed on the second display).

Logical segmentation of touchpad 116 as described above may have many advantages. For example, a user may desire to perform document comparison between a document displayed on the first display and a document displayed on the second display. Traditionally, to perform such task a user may need to use touchpad 116 to move a cursor from one display to the other, which may require several finger swipes of a user across touchpad 116. However, with logical segmentation of touchpad 116 enabled, a user may independently swipe a respective cursor in each of the first display and second display up and down to perform the desired comparison and/or editing.

As another example, with logical segmentation of touchpad 116 enabled, a user may be able to simultaneously perform multiple tasks, such as gaming on the first screen using first zone 302 and using a chat application on the second screen using second zone 304.

As an additional example, with logical segmentation of touchpad 116 enabled, a user may be able to cast the contents of an external device such as a smartphone or tablet (effectively serving as the second display) onto a portion of the first display via wireless transmissions (e.g., Bluetooth), and simultaneously control the first display using first zone 302 and control the external device using second zone 304.

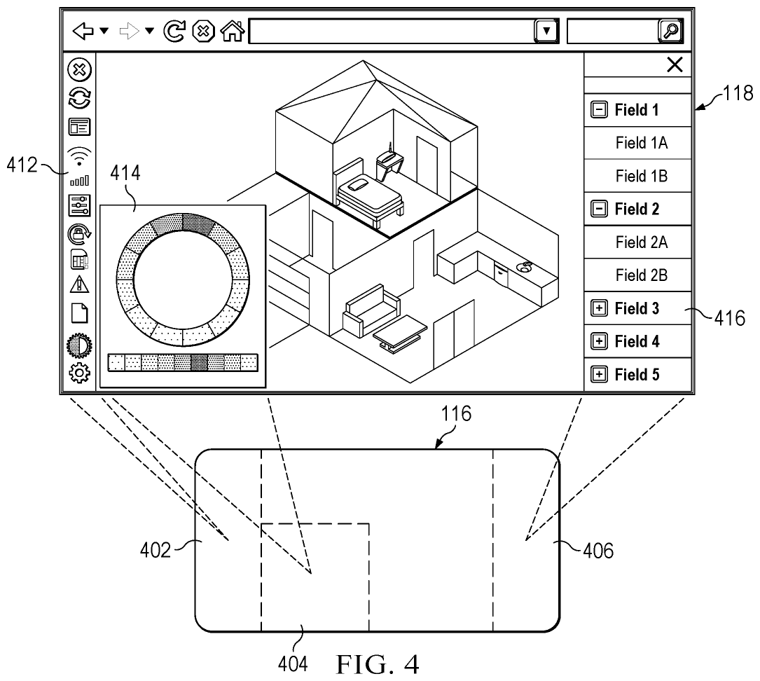

Although the foregoing contemplates the use of first zone 302 and second zone 304 for controlling contents of two different displays, in some embodiments, touchpad 116 may also be segmented into multiple zones, with each zone configured to manipulate a particular feature of a single display. For example, FIG. 4 illustrates the logical segmentation of touchpad 116 into a first zone 402 for manipulating a first segment 412 of display 118, a second zone 404 for manipulating a second segment 414 of display 118, and a third zone 406 for manipulating a third segment 416 of display 118, in accordance with embodiments of the present disclosure. Accordingly, an application executing on information handling system 101 in concert with a touchpad driver and operating system of information handling system, may process user interaction with first zone 402 to manipulate first segment 412, process user interaction with second zone 404 to manipulate second segment 414, and process user interaction with third zone 406 to manipulate third segment 416.

In addition to different zones of touchpad 116 manipulating different segments of display 118, touchpad 116 may be segmented into multiple zones wherein each zone manipulates a particular element displayed on display 118. For example, in a gaming context, a zone of touchpad 116 comprising the left half of touchpad 116 may control hands of an avatar displayed on display 118 while a second zone of touchpad 116 comprising the right half of touchpad 116 may control feet of an avatar displayed on display 118. As another example, also in a gaming context, a first zone of touchpad 116 comprising the left half of touchpad 116 may control a left hand of an avatar displayed on display 118 while a second zone of touchpad 116 comprising the right half of touchpad 116 may control a right hand of an avatar displayed on display 118. As a further example, also in a gaming context, a first zone of touchpad 116 comprising the left half of touchpad 116 may control an avatar displayed on display 118 for a first user while a second zone of touchpad 116 comprising the right half of touchpad 116 may control an avatar displayed on display 118 for a second user.

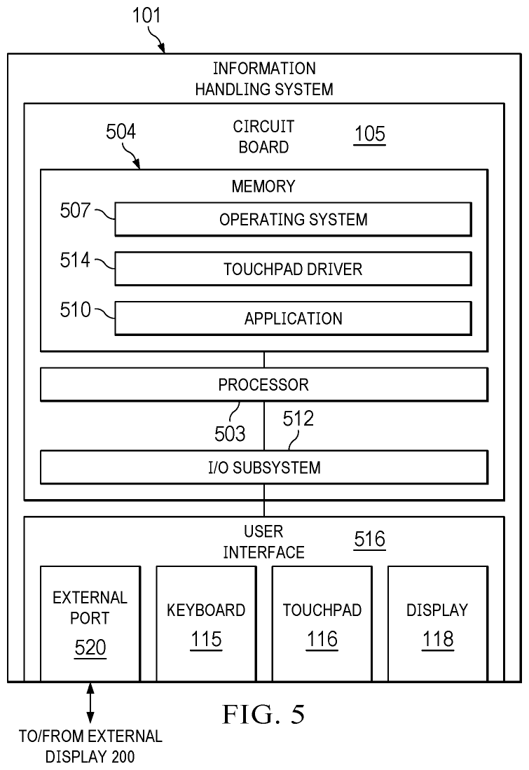

FIG. 5 illustrates a functional block diagram of an example information handling system 101, in accordance with embodiments of the present disclosure. As depicted in FIG. 5, information handling system 101 may include a processor 503, a memory 504 communicatively coupled to processor 503, an input/output (I/O) subsystem 512 communicatively coupled to processor 503, and a user interface 516 communicatively coupled to I/O subsystem 512.

Processor 503 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 503 may interpret and/or execute program instructions and/or process data stored in memory 504 and/or another component of information handling system 101.

Memory 504 may be communicatively coupled to processor 503 and may include any system, device, or apparatus configured to retain program instructions and/or data for a period of time (e.g., computer-readable media). Memory 504 may include RAM, EEPROM, a PCMCIA card, flash memory, magnetic storage, opto-magnetic storage, or any suitable selection and/or array of volatile or non-volatile memory that retains data after power to information handling system 101 is turned off. As shown in FIG. 1, memory 504 may have stored thereon an operating system 507, a touchpad driver 514, and an application 510.

Operating system 507 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by host operating system 507. Active portions of operating system 507 may be read from memory 504 for execution by processor 503.

Touchpad driver 514 may comprise any program of executable instructions, or aggregation of programs of executable instructions, configured to provide a software interface to touchpad driver 514, in order to enable operating system 507 and/or application 510 to access hardware functions of touchpad 116.

Application 510 may comprise any program of executable instructions, or aggregation of programs of executable instructions, configured to carry out a specific task other than one relating to the operation of the computer itself. Such application may comprise a productivity application (e.g., word processor, spreadsheet application, image editing application), a game, or any other suitable application.

As noted above, in some embodiments, operating system 507 and touchpad driver 514 may be configured to operate in concert to process user interaction with each of multiple zones of touchpad 116 to manipulate respective features of one or more of display 118 and/or external display 200. In other embodiments, operating system 507, touchpad driver 514, and application 510 may be configured to operate in concert to process user interaction with each of multiple zones of touchpad 116 to manipulate respective features of one or more of display 118 and/or external display 200.

I/O subsystem 512 may comprise any suitable system, device, or apparatus generally operable to receive and transmit data to or from or within information handling system 101. I/O subsystem 512 may represent, for example, any one or more of a variety of communication interfaces, graphics interfaces, video interfaces, user input interfaces, and peripheral interfaces.

User interface 516 may comprise any instrumentality or aggregation of instrumentalities by which a user may interact with information handling system 101. For example, user interface 516 may permit a user to input data and/or instructions into information handling system 101 (e.g., via a keyboard 115, a touchpad 116, and/or other suitable component), and/or otherwise manipulate information handling system 101 and its associated components. User interface 516 may also permit information handling system 101 to communicate data to a user, e.g., by way of a display 118 and/or external display 200 coupled to external port 520 of user interface 516.

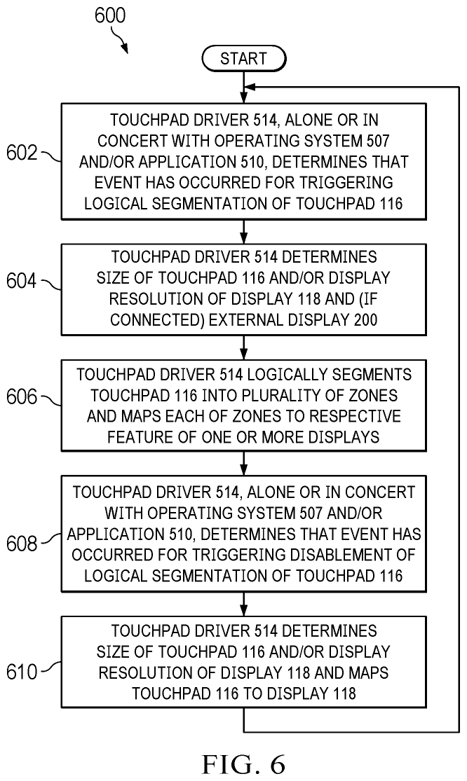

FIG. 6 illustrates a flow chart of an example method 600 for enabling a touchpad with multiple zones for different user interface functionality, in accordance with embodiments of the present disclosure. According to some embodiments, method 600 may begin at step 602. As noted above, teachings of the present disclosure may be implemented in a variety of configurations of information handling system 101. As such, the preferred initialization point for method 600 and the order of the steps comprising method 600 may depend on the implementation chosen.

At step 602, touchpad driver 514, alone or in concert with operating system 507 and/or application 510, may determine if an event has occurred for triggering logical segmentation of touchpad 116. For example, in some embodiments, such event may include the coupling of external display 200 to external port 520. In these and other embodiments, such event may include the user inputting an indication, such as typing of a hotkey sequence, indicating a desire for logical segmentation of touchpad 116.

At step 604, in response to the event, touchpad driver 514 may determine a size of touchpad 116 and/or a display resolution of display 118 and (if connected) external display 200.

At step 606, touchpad driver 514 may logically segment touchpad 116 into a plurality of zones, and map each of the zones to a respective feature of one or more displays. For example, if external display 200 is coupled to information handling system 101, touchpad driver 514 may map a first zone of touchpad 116 to display 118 and a second zone of touchpad 116 to external display 200. As another example, if external display 200 is not coupled, touchpad driver 514 may map each zone of touchpad 116 to a respective corresponding segment of display 118. As a further example, touchpad driver 514 may map each zone of touchpad 116 to a respective feature (e.g., avatar, feature of avatar, cursor, etc.) of one of more displays. After such segmentation and mapping, touchpad driver 514 may, alone or in concert with operating system 507 and/or application 510, process user interaction with touchpad 116 in accordance with the mapping in order to manipulate the respective features.

In some embodiments, in response to the event, touchpad driver 514, alone or in concert with operating system 507 and/or application 510, may display to display 118 or external display 200 a window for the user to select one or more options with respect to displayed features associated with the zones, such as, for example, appearances of cursors associated with the different zones.

In these or other embodiments, while logical segmentation of touchpad 116 is enabled, touchpad driver 514, alone or in concert with operating system 507 and/or application 510, may cause an indication to be displayed (e.g., via a visual indicator such as a light-emitting diode proximate to touchpad 116) indicating that logical segmentation of touchpad 116 is enabled.

At step 608, touchpad driver 514, alone or in concert with operating system 507 and/or application 510, may determine if an event has occurred for triggering disablement of logical segmentation of touchpad 116. For example, in some embodiments, such event may include the decoupling of external display 200 from external port 520. In these and other embodiments, such event may include the user inputting an indication, such as typing of a hotkey sequence, indicating a desire for ceasing logical segmentation of touchpad 116.

At step 610, in response to the event, touchpad driver 514 may determine a size of touchpad 116 and/or a display resolution of display 118 and map touchpad 116 to display 118. After completion of step 610, method 600 may proceed again to step 602.

Although FIG. 6 discloses a particular number of steps to be taken with respect to method 600, method 600 may be executed with greater or lesser steps than those depicted in FIG. 6. In addition, although FIG. 6 discloses a certain order of steps to be taken with respect to method 600, the steps comprising method 600 may be completed in any suitable order.

Method 600 may be implemented using information handling system 101 or any other system operable to implement method 600. In certain embodiments, method 600 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a processor;
a touchpad communicatively coupled to the processor; and
non-transitory computer-readable media communicatively coupled to the processor and having stored thereon a program of instructions configured to, when read and executed by the processor in response to a trigger for enabling logical segmentation of the touchpad, logically segment the touchpad into a plurality of zones and map each zone to a respective corresponding cursor displayed on one or more displays communicatively coupled to the processor such that user interaction with each of the plurality of zones manipulates the respective corresponding cursor of such zones on the one or more displays.

2. The information handling system of claim 1, the instructions further configured to, in response to a trigger for disabling logical segmentation of touchpad, map the touchpad to a single display associated with the information handling system.

3. The information handling system of claim 1, wherein the trigger comprises one or more of: communicative coupling of an external display to the information handling system and a user input indicating a desire to enable logical segmentation of the touchpad.

4. The information handling system of claim 1, wherein the one or more displays comprise a single display and mapping each zone to a respective corresponding cursor comprises mapping each zone to a respective segment of the single display.

5. The information handling system of claim 1, wherein the one or more displays comprise a plurality of displays and mapping each zone to a respective corresponding cursor comprises mapping each zone to a respective display of the plurality of displays.

6. The information handling system of claim 1, wherein mapping each zone to a respective corresponding cursor comprises mapping each zone to a respective element displayed on the one or more displays.

7. A method comprising:
logically segmenting a touchpad of an information handling system into a plurality of zones and mapping each zone to a respective corresponding cursor displayed on one or more displays communicatively coupled to a processor of the information handling system such that user interaction with each of the plurality of zones manipulates the respective corresponding cursor of such zones on the one or more displays.

8. The method of claim 7, wherein logically segmenting occurs in response to a trigger for enabling logical segmentation of the touchpad.

9. The method of claim 8, wherein the trigger comprises one or more of: communicative coupling of an external display to the information handling system and a user input indicating a desire to enable logical segmentation of the touchpad.

10. The method of claim 7, further comprising, in response to a trigger for disabling logical segmentation of touchpad, mapping the touchpad to a single display associated with the information handling system.

11. The method of claim 7, wherein the one or more displays comprise a single display and mapping each zone to a respective corresponding cursor comprises mapping each zone to a respective segment of the single display.

12. The method of claim 7, wherein the one or more displays comprise a plurality of displays and mapping each zone to a respective corresponding cursor comprises mapping each zone to a respective display of the plurality of displays.

13. The method of claim 7, wherein mapping each zone to a respective corresponding cursor comprises mapping each zone to a respective element displayed on the one or more displays.

14. An article of manufacture comprising:
a non-transitory computer readable medium; and
computer-executable instructions carried on the computer readable medium, the instructions readable by a processing device, the instructions, when read and executed, for causing the processing device to:
logically segment a touchpad of an information handling system into a plurality of zones and map each zone to a respective corresponding cursor displayed on one or more displays communicatively coupled to a processor of the information handling system such that user interaction with each of the plurality of zones manipulates the respective corresponding cursor of such zones on the one or more displays.

15. The article of claim 14, wherein logically segmenting occurs in response to a trigger for enabling logical segmentation of the touchpad.

16. The article of claim 15, wherein the trigger comprises one or more of: communicative coupling of an external display to the information handling system and a user input indicating a desire to enable logical segmentation of the touchpad.

17. The article of claim 14, the instructions for further causing the processing device to, in response to a trigger for disabling logical segmentation of touchpad, map the touchpad to a single display associated with the information handling system.

18. The article of claim 14, wherein the one or more displays comprise a single display and mapping each zone to a respective corresponding cursor comprises mapping each zone to a respective segment of the single display.

19. The article of claim 14, wherein the one or more displays comprise a plurality of displays and mapping each zone to a respective corresponding cursor comprises mapping each zone to a respective display of the plurality of displays.

20. The article of claim 14, wherein mapping each zone to a respective corresponding cursor comprises mapping each zone to a respective element displayed on the one or more displays.
